(19) United States
(12) Patent Application Publication
(10) Pub. No.: US 2005/0062455 A1
(43) Pub. Date: Mar. 24, 2005

(54) Battery powered device and method employing monitored usage to recommend battery type

(76) Inventors: Donald J. Stavely, Windsor, CO (US); Andrew C. Goris, Loveland, CO (US); Linda A. Kennedy, Fort Collins, CO (US); Mary E. Moses, Windsor, CO (US); George W. Prokop, Loveland, CO (US); Robert F. Yockey, Holzgerlingen (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/658,138

(22) Filed: Sep. 9, 2003

(51) Int. Cl. H02J 7/00

(52) U.S. Cl. 320/106

(57) ABSTRACT

The present invention recommends a battery type to use with a battery-powered device based on a use model determined for the device. The recommended battery type has a constructive effect on one or both of device performance and battery performance or life during device usage according to the use model. The present invention further monitors the device usage to determine the use model. Both the use model and the recommended battery type are adaptive based on the monitored device usage. The battery-powered device has a use model-based adaptive battery type selection that includes a monitor that determines the use model, a controller, a memory and a computer program stored in the memory and controlled by the controller. The computer program includes instructions that recommend a battery type based on a determined use model. A method of recommending a battery type is implementable by the computer program.

### TECHNICAL FIELD

The invention relates to electronic devices. In particular, the invention relates to battery-powered devices and batteries used therein.

### BACKGROUND OF THE INVENTION

Battery-powered electronic devices, devices that derive some or all of their operating power from a battery, are popular, widely available, and in widespread use. In large part, the value and marketability of such devices depend on a reliable source of battery power. Choosing a battery for use in the device is a critical aspect of providing such a reliable source. Moreover, performance of the device and of the battery power source often depends on how the device is used while operating on battery power.

In the past, choosing a battery was mainly limited to choosing from among battery brands or battery supplier/manufacturers that offered an appropriate battery size or form factor for a given device. Recently however, many modern battery-powered devices are being designed to accept and utilize batteries of differing types or chemistries. While accepting a variety different battery types, a given battery powered device may provide better performance with one battery type than with another. Thus, in addition to brand, a user of a battery-powered device often is faced with choosing the battery type or chemistry of the battery that is to be used in the device.

When a device accepts a battery selected from among more than one battery type, a choice of a specific battery type often impacts the performance of the device. Specifically, a ‘use model’ or how the device is used generally influences which battery type of several available battery types is best suited for the device. Thus, given a particular use model, a user may realize better performance from the device and/or from the chosen battery when using a first battery type rather than when using a second battery type, for example. On the other hand, another user of the device following a different use model may achieve better performance with the second battery type than with the first battery type.

Accordingly, it would be advantageous to have a way for a user of an electronic device to make a selection of battery type based on a use model for the device. Moreover, it would be advantageous if the use model-based selection adapted to a particular usage and user of the device. Such an adaptive use model-based battery type selection would solve a long-standing need in the area of battery-powered devices.

### SUMMARY OF THE INVENTION

The present invention determines or recommends a battery type for use in a battery-powered device based on a use model for the device. In particular, a recommended battery type is the type that at least does not decrease, typically will increase or improve, and preferably will optimize, a performance of the device and/or a performance of the battery installed in the device. In other words, the recommended battery type has a constructive effect on one or both of device performance and battery performance or life after a battery of the recommended type is installed in the device.

Moreover, the use model is determined from an actual usage of the device. As such, the use model that determines the battery type recommendation adapts to a particular user of the device over time. The recommended battery type is selected from among a set of battery types available for use with the device. Furthermore, as a result of adapting to a change in the use model associated with a given user, the recommended battery type may differ from one time to another to facilitate at least maintaining or typically enhancing one or both of the performance of the device and the performance or life of the battery for the user.

In an aspect of the present invention, a method of recommending a battery type based on a use model of a device is provided. The method comprises recommending the battery type that has a constructive effect on one or both of device performance and battery performance or life during device usage. The method of recommending assists a user of the device in selecting from among a set of alternative battery types that may be used with the device. The method facilitates improving a battery related performance of the device based on how the user actually uses the device. In particular, use of a suggested battery type in accordance with the method may result in a more satisfactory battery life and/or a better performance of the device than when using a battery chosen arbitrarily from among the set of alternative battery types. The method is applicable to battery-powered devices that may employ a battery selected from more than one battery types.

In some embodiments, the method of recommending a battery type based on a use model of a device comprises monitoring usage of the device to determine the use model; and recommending the battery type based on the monitored usage. The method optionally may further comprise determining a type of a battery that is installed during the monitoring.

In another aspect of the present invention, a device having a use model-based adaptive battery type selection is provided. The device monitors usage of the device by a user and recommends a battery type based on the monitored usage. The device comprises means for monitoring usage of the device by a user that determines a use model, and means for recommending a battery type based on the determined use model, the battery type being from a set of battery types usable with the device. In some embodiments, the means for monitoring is an energy consumption monitor that monitors energy consumed from a battery installed in the device as a function of time while the device is being used. In some embodiments, the means for recommending is a mapping function that relates monitored usage from the monitoring means to a recommended battery type from the set of battery types. Depending on the embodiment, the means for recommending may be embodied in a computer program executed by a controller of the device and stored in memory of the device. In some embodiments, the recommendation of battery type is communicated to a user of the device by a user interface of the device.

Certain embodiments of the present invention have other features in addition to and in lieu of the features described hereinabove. These and other features and advantages of the invention are detailed below with reference to the following drawings.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1A illustrates a flow chart of an embodiment of a method of recommending a battery type based on a use model of a device according to an embodiment of the present invention.

FIG. 1B illustrates a flow chart of a method of recommending a battery type including optionally determining a type of installed battery according to another embodiment of the present invention.

FIG. 2A illustrates a flow chart of an embodiment of monitoring according to the present invention.

FIG. 2B illustrates a flow chart of monitoring according to another embodiment of the present invention.

FIG. 2C illustrates a flow chart of monitoring according to another embodiment of the present invention.

FIG. 3 illustrates an exemplary graphical approach to selecting a battery type to recommend according to an embodiment of the present invention.

FIG. 4 illustrates a block diagram of an embodiment of a battery-powered device having a use model-based battery type selection according to an embodiment of the present invention.

FIG. 5 illustrates a perspective side view of an exemplary battery-powered digital camera device according to an embodiment of the present invention.

### DETAILED DESCRIPTION OF THE INVENTION

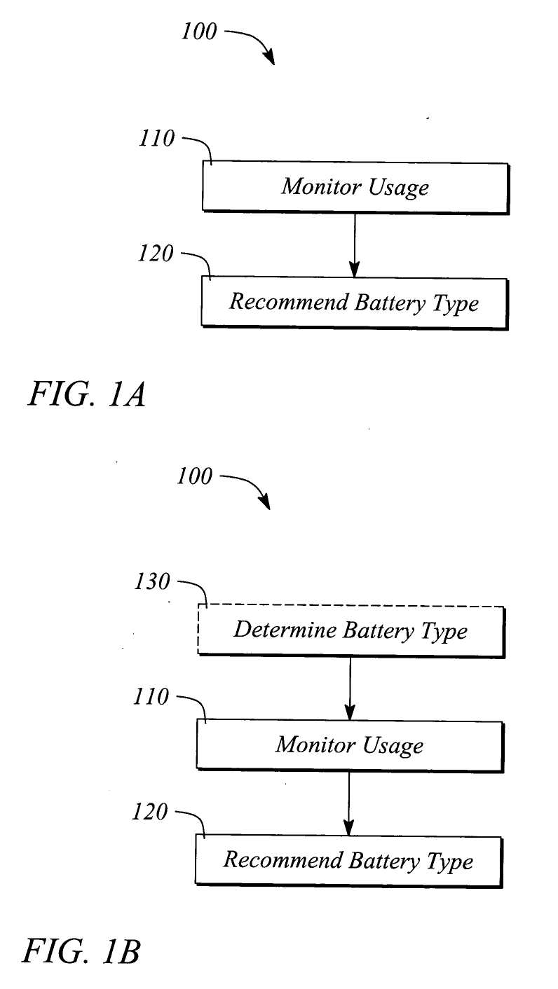

FIG. 1A illustrates a flow chart of an embodiment of a method 100 of recommending a battery type based on a use model of a device according to an embodiment of the present invention. The method 100 assists a user of the device in selecting a particular battery type from among a set of battery types that may be used in or with the device. In particular, the method 100 recommends the battery type with performance characteristics that ‘best fit’ a way the device is used or operated. The way the device is used or operated is referred to herein as a ‘use model’ of the device. By ‘best-fit’ it is meant that the recommended battery type at least maintains, typically increases or improves, or preferably optimizes a device performance with such a use model. Selecting and employing a battery of the recommended battery type in accordance with the method 100 may also at least maintain, typically increase or improve, or preferably optimize a performance or a life of the selected battery for the user and/or the use model. In other words, a best-fit battery type has a constructive effect on one or both of the device performance and the battery life or performance during device usage in accordance with the use model.

The recommended best-fit battery type is determined adaptively by the method 100 according to the present invention. In particular, the best-fit battery is determined adaptively according to an actual use model of the device developed by monitoring device usage. Thus, even if the user changes the way the device is used (i.e., modifies the use model), the method 100 of recommending adapts to the change. The recommended battery type after the change, according to the method 100, still represents a best-fit battery type for the respective use model even though the recommended best-fit battery type may be the same or different before and after the change in the use model.

Herein, battery ‘type’ is used interchangeably with battery ‘chemistry’. In particular, the chemistry or type of battery generally refers to the specific combination of electrolytes and electrode materials used in the battery to create and sustain chemical reactions within the battery that produce the electricity. A variety of different battery chemistries are currently commercially available including alkaline, high-drain alkaline, nickel-metal hydride (NiMH), nickel-cadmium (NiCd), and photo lithium or lithium-iron sulfide (Li—FeS₂). Many of these battery types are available in one or more of a variety of battery sizes or form factors, including, but not limited to, an ‘AA’ size, an ‘AAA’ size, a ‘C’ size, and a ‘D’ size as well as various ‘coin’ cell sizes and custom sizes.

Battery type also may refer to a rechargeability of a particular battery. For example, battery types such as alkaline and high drain alkaline are considered to be relatively non-rechargeable battery types while NiMH, NiCd, and most lithium batteries are rechargeable types. The present invention is not dependent on or limited to the above-listed exemplary chemistries but instead is applicable to any battery chemistry or other characteristic of a battery that differentiates a battery type from other battery types.

A particular choice of battery type for use in devices that accept more than one battery type can and does affect the performance of the device and/or the performance of a chosen battery when employed in the device. Consider a digital camera as the electronic device, for example. A first user of the exemplary digital camera, who follows a first use model characterized by high-drain usage of the camera, may find that better performance is provided by a NiCd or a NiMH battery than by a Li—FeS₂ battery. Examples of high-drain usage in a digital camera include, but are not limited to, frequent zoom lens or focus operations and/or extensive use of display-based image preview/review modes. Alternatively, a second user of the digital camera may employ a second use model characterized by long periods of storage or relative low drain usage. The second user may find that a Li—FeS₂ battery is preferable to a NiCd battery, for example.

Another example situation in which a choice of battery type may impact performance involves using an alkaline battery in a device such as, but not limited to, a digital camera. Alkaline batteries typically provide generally poorer performance in high-drain applications. The poorer high-drain performance is due in large part to a relatively high internal resistance associated with alkaline batteries. As such, for some users and associated use models, an alkaline battery represents a relatively poorer choice for powering the exemplary digital camera in all but certain emergency situations. However, for other users, namely users who either do not use or at least rarely use high-drain modes and features of the digital camera, an alkaline battery may be an acceptable or perhaps even a preferred battery type.

Referring again to FIG. 1A, the method 100 of recommending a battery type comprises monitoring 110 a usage of the device. In particular, one or more parameters associated with the device usage are monitored 110. Generally, which parameter or set of parameters are monitored 110 may vary from one type of device to another and typically are dependent on the device type. However, the monitored 110 parameters preferably relate to the performance of the battery installed or used in the device. In particular, the monitored 110 parameters are generally chosen to provide monitored results or data that yield insight into the performance of the battery and/or the device using the battery with respect to a respective battery type of the battery being used. Data collected by monitoring 110 represents the use model of the device.

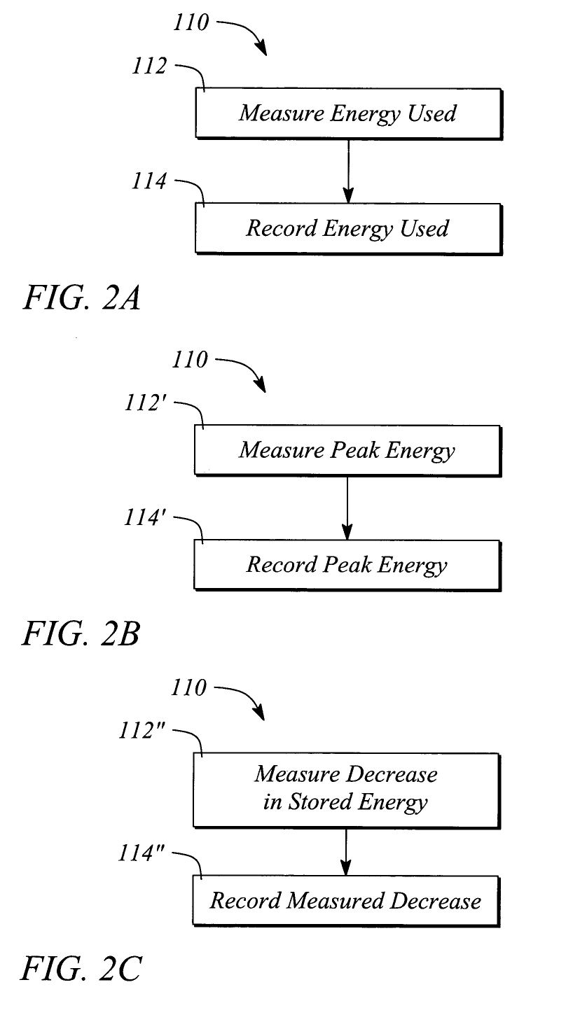

FIG. 2A illustrates a flow chart of an embodiment of monitoring 110 according to the present invention. As illustrated in FIG. 2A, monitoring 110 comprises measuring 112 energy used by the device, and recording 114 the measured energy used with respect to time. In other words, energy used by the device is measured 112 and recorded 114, such that monitoring 110 produces a ‘time record’ of the energy usage. Alternatively in this embodiment of monitoring 110, energy delivered by the battery to the device is measured 112 and recorded 114.

The time record of energy usage produced by monitoring 110 may include one or more discharge cycles of the battery. For example, energy usage in the time record may be averaged over a plurality of discharge cycles. The time record thus recorded 114 may be stored in a memory of the device as a table, for example.

Energy usage may be measured 112 in a number of different ways. In particular, energy usage may be measured 112 directly or indirectly. For example, a current flowing from the battery may be directly measured 112 in the device using a current sensor or an equivalent means placed between the battery and the device. The current sensor may measure 112 the current at discrete times or continuously with respect to time. Since batteries of most battery types essentially act as a constant voltage source throughout a large portion of a discharge cycle, the energy usage is proportional to the measured current. Further, a battery voltage may be measured 112 using a voltage sensor (e.g., an analog to digital converter) either in addition to or instead of measuring 112 current. In particular, measuring 112 both current and voltage may improve an accuracy of the energy measurement, especially near an end of discharge or an end of battery life.

Alternatively, another current and/or voltage in the device that is proportional to the energy flowing from the battery may be measured 112. The energy usage is determined from a known relationship or proportionality between the other current and/or voltage and the energy flowing from the battery. For example, a current in a power supply of the device may be measured 112. If the current in the power supply is proportional to the current flowing from the battery, the energy usage can be determined from the power supply current.

FIG. 2B illustrates a flow chart of monitoring 110 according to another embodiment of the present invention. As illustrated in FIG. 2B, monitoring 110 comprises measuring 112′ and recording 114′ a peak or maximum energy used or drawn from the battery in each of a series of time intervals. Equivalently, a peak power per time interval may be measured 112′ and recorded 114′. For example, a peak energy may be measured 112′ and recorded 114′ in a first time interval, and then again in a second time interval, and so on. The intervals may be 1-second intervals or 1-minute intervals, for example. Further, the time intervals may be equal to one another or unequal. Thus, monitoring 110 generates a record of peak energy/power as a function of time interval.

FIG. 2C illustrates a flow chart of monitoring 110 according to another embodiment of the present invention. As illustrated in FIG. 2C, monitoring 110 comprises measuring 112″ a decrease in an energy stored in the battery of the device as a function of time. For example, the energy remaining in the battery may be measured 112″ periodically using a fuel gauging capability or functionality of the device. From the periodic measurements, the rate of decrease in stored energy is determined and used as the measured 112″ decrease. Monitoring 110 further comprises recording 114″ the measured decrease 112″ as a function of time during monitoring 110.

In yet other embodiments, an energy usage is monitored 110 indirectly (not illustrated). Energy usage may be monitored 110 indirectly using information regarding operations performed by the device. As such, monitoring 110 comprises recording operational modes of and/or operations performed by the device as a function of time. Monitoring 110 further comprises computing an energy usage from the recorded operational mode and information regarding an energy used by the recorded operational mode.

In essence, if the amount of energy consumed or used by a given operation is known, then when the device performs that operation, the energy used is simply the known amount of energy consumed by that operation. Data for known amounts of energy used per operation are generally determined empirically for a given device or class of devices by a manufacturer of the device and stored in a memory of the device for later use in determining the energy usage. The data is often stored in the form of a look-up table that has an entry for each unique operation of the device.

In some cases, a total energy consumed by the device when performing a given operation is known a priori. Such operations are ones that have a consistent or relatively consistent duration and repeatable energy/power utilization. For such operations, the energy used each time such operation is performed by the device is determined by simply noting that such operation has been performed and using the a priori knowledge of energy consumed. The energy value for that operation is found in the look-up table, for example.

In other cases, a duration of some operations may not be consistent so that a priori knowledge of total energy used by the device cannot be obtained from knowing the operation by itself. In such cases, a predetermined, known power/energy used per unit time during each one of these operations is employed to determine the energy usage. For example, with operations of inconsistent duration, the energy used may be determined by measuring the elapsed time tₒₚₑᵣₐₜᵢₒₙ of the operation. The measured elapsed time tₒₚₑᵣₐₜᵢₒₙ is then multiplied by a power value found in the look-up table for the operation to compute the energy used for that instance of the operation. Thus, by tracking the operations performed by the device and using either an energy consumption that is known a priori or a combination of a known power and the measured elapse time tₒₚₑᵣₐₜᵢₒₙ for each operation, the energy usage is determined and recorded as a time sequence.

In yet other embodiments, monitoring 110 comprises recording a sequence of operations or operational modes without explicitly determining the energy used. Alternatively, monitoring 110 may comprise counting and recording a frequency of use or occurrence of each operation or operational mode while the device is used. Thus, monitoring 110 produces a record of which operational modes are used and/or how often each mode is used. Preferably, the record includes an indication of time. For example, monitoring 110 may record a length of time that the device is in a standby mode, a length of time the device is stored (i.e., in a shutdown mode or condition), and/or a length of time the device is active and in use in each of several operational modes. Additionally, monitoring 110 may include combinations of the embodiments described hereinabove.

Furthermore, monitoring 110 may include a time during which the device is ‘turned off’ in addition to when the device is operating. For example, many devices include real-time clock circuitry for maintaining time and date information. Thus, the frequency of use and the duration of non-use may be advantageously incorporated into the monitored 110 data.

Referring again to FIG. 1A, the method 100 further comprises recommending 120 a battery type based on the monitored 110 usage. In particular, the monitored 110 usage results for the device are employed to determine a battery type that best fits the observed usage. Once a best-fit battery type is determined, the battery type is recommended to the user of the device. In general, how the best-fit battery type is determined depends on what parameters are monitored 110, which battery types are contained in a set of available battery types for the device, and a particular type or class of the device being used.

As mentioned hereinabove, recommending 120 employs data collected by monitoring 110 to determine a best-fit battery type. In particular, the best-fit battery type may be determined using a database of characteristics for the set of battery types. In some cases, the database contains data for each battery type compiled prior to use of the device by the user. In other cases, the database may be constructed from data collected by monitoring 110 and battery type recommendation 120 over a period of time. Thus, the database is developed dynamically while the user uses the device.

Numerous approaches are known and may be employed in determining the best-fit battery for recommending 120 using such a database. In particular, many databases are designed and equipped with functions that facilitate mapping the results of monitoring 110 into a particular entry of the database. Such mapping functions are sometimes referred to as ‘classifiers’ or classification systems and are well known in the database arts. Other applicable mapping, selection, or data mining functions include, but are not limited to, Naive Bayes, Density Estimation, Support Vector Machines, Clustering, Frequent Itemsets, Association Rules and Decision Trees. All such approaches and database classification systems are within the scope of the present invention.

Consider, for example, a device that is designed to use batteries selected from an exemplary set having three different battery types. Moreover, assume that a first battery type of the set provides a high peak current capability relative to other battery types of the set, a second battery type of the set provides a long storage life but a lower peak current capability than the first battery type, and a third battery type of the set provides a higher overall energy storage capacity but lower peak current and a shorter storage life than either the first or second battery of the set.

Now consider the exemplary device employing the method 100 described hereinabove. In an example usage of the device, it is determined from monitoring 110 that the device use model includes long periods of storage between short periods of operation of relatively low current usage. From such a monitoring 110 result, the best-fit battery type of the set is the second battery type since the second battery type provides long storage life. Thus, the second battery type is recommended 120 to the user.

In another example, the device has a use model as determined from monitoring 110 exemplified by long periods of operation and many high peak current operations. The best-fit battery type of the set in this exemplary case is the first battery type. Thus, the first battery type is recommended 120 to the user.

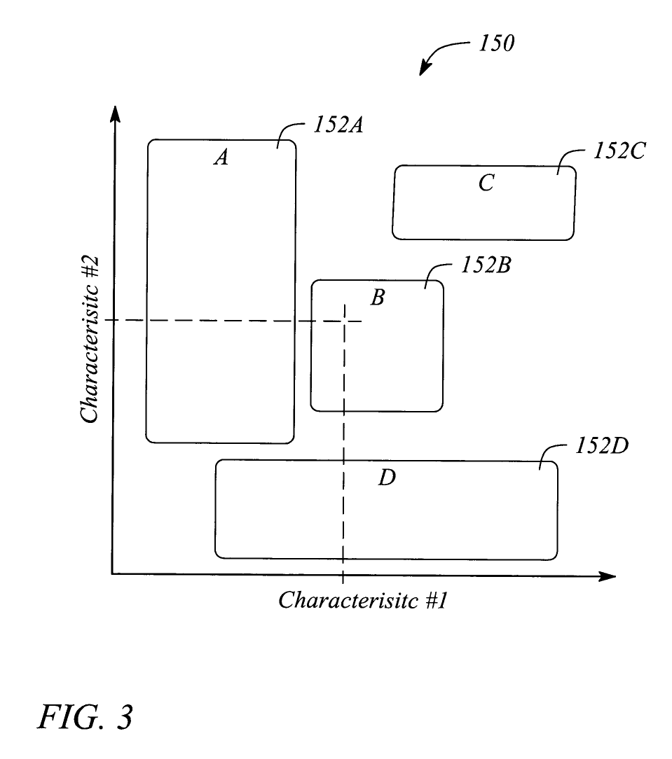

FIG. 3 illustrates an exemplary graphical approach to selecting a battery type to recommend 120 according to an embodiment of the present invention. In particular, a pair of characteristics of a set of battery types that may be used in an exemplary device are plotted with respect to one another in a graph 150. Regions in the graph 150 illustrated in FIG. 3 correspond to particular battery types. For example, a first battery type ‘A’ has characteristics that define a first region 152A of the graph 150, a second battery type ‘B’ has characteristics that define a second region 152B, and so on. Results of monitoring 110 a usage of the device may be plotted on the graph 150 as indicated by a pair of ‘dashed’ lines. An intersection of the dashed lines indicates a region and by association, a battery type that best fits the monitored 110 results. Thus for the example illustrated in FIG. 3, the monitored 110 results indicate that the second battery type ‘B’ is a best-fit battery type (i.e., the monitored characteristics 110 intersect in the region 152B of battery type ‘B’). Thus, battery type ‘B’ is the recommended 120 battery type in the example.

Recommending 120 also may include suggesting a source for the recommended 120 battery type. For example, a manufacturer and part number may be included in the recommendation 120 to the user. Further, retail sources that feature the recommended battery may be provided to the user. For example, a local retail establishment that sells a particular type and size of battery may be provided to the user along with the recommendation 120 of a best-fit battery type. In another example, devices that have access to the Internet may include connecting to a website. The website may facilitate purchasing the recommended 120 battery type, for example.

The method 100 of recommending optionally may further comprise determination of a type of battery installed in the device (i.e., during or before monitoring 110). FIG. 1B illustrates a flow chart of a method 100 of recommending a battery type including optionally determining 130 a type of installed battery according to another embodiment of the present invention. In particular, determining 130 the type of battery installed is performed before recommending 120 and even may be performed before or during monitoring 110. Moreover, determining 130 may be used to modify recommending 120. For example, if the best-fit battery type is the installed battery type as indicated by determining 130, then recommending 120 may be omitted or recommending 120 may simply inform the user that no change in battery type is recommended 120.

The installed battery type may be determined 130 in a number of different ways. For example, when a user installs a battery in the device, an indication of the battery type may be input by the user through a user interface of the device. The input identification then serves to determine 130 the battery type. Alternatively, a test may be performed on the installed battery to determine 130 the battery type. For example, several such techniques for determining 130 battery type are described by Bean et al. in U.S. Pat. No. 6,400,123 B1 and Bean et al., U.S. Pat. No. 6,215,275, both of which are incorporated by reference herein. The cited methods, as well as any other method that determines battery type/chemistry of a battery installed in the device may be used in determining 130 and are within the scope of the present invention. The installed battery type may be determined 130 without limitation one or more of when the battery compartment is accessed, when a battery type is recommended 120, periodically during use of the device, when the device is first turned ON, and when a use model changes, for example. These and other events that may trigger the determination 130 not listed here are within the scope of the present invention.

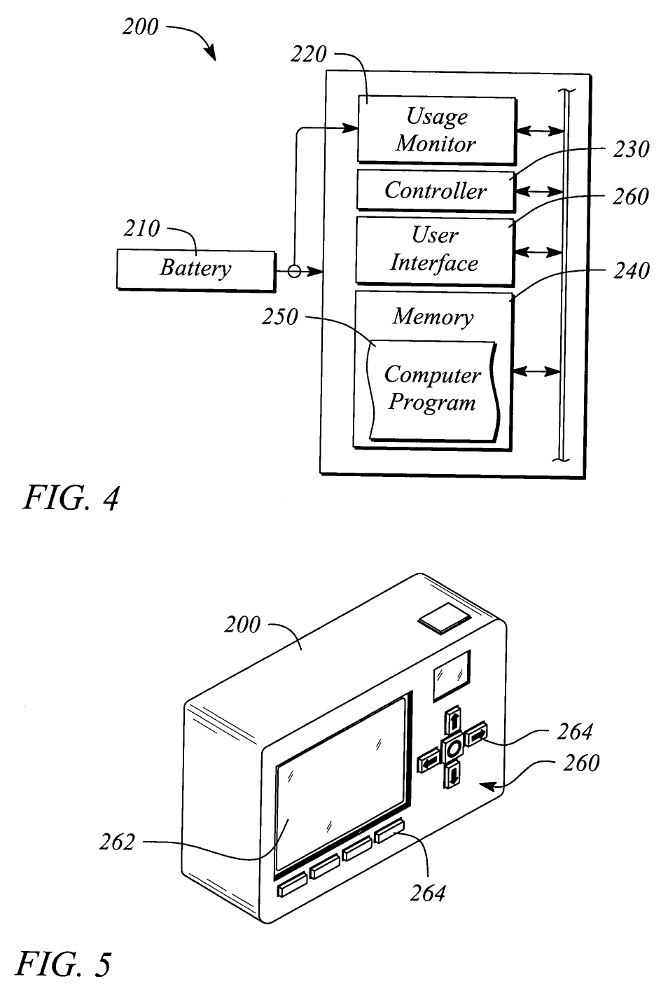

FIG. 4 illustrates a block diagram of an embodiment of a battery-powered device 200 having a use model-based battery type selection according to an embodiment of the present invention. The device 200 may be virtually any battery-powered device 200 modified to provide use model-based battery type selection according to the present invention including, but not limited to, a digital camera, a personal digital assistant (PDA), a laptop computer, a cellular telephone, an MP3 player and a variety of battery-powered toys and learning devices for children.

In accordance with the present invention, the battery-powered device 200 monitors a device usage and determines a use model of the device 200. From the determined use model, the device 200 recommends a battery type. A user of the device 200 employs the recommended battery type for use in the device 200. The recommended battery type is a battery type that best fits (as defined above) the determined use model of the device 200.

In general, the battery-powered device 200 comprises means for monitoring, and means for recommending (not illustrated). The means for monitoring monitors usage of the device 200. For example, the means for monitoring may employ any of the embodiments of monitoring 110 described hereinabove.

The monitored usage is then employed by the means for recommending to produce a recommendation of a best-fit battery type. For example, the means for recommending may comprising a mapping function or functions that relate monitored usage to a particular battery type contained in a database or a list of battery types available for use with the device.

The recommendation is presented or communicated to the user of the device 200. The best-fit battery type is a battery type selected from among a set of battery types that may be used with the device 200. Preferably, the best-fit battery type optimizes a performance characteristic of the device 200 with respect to the determined use model of the device 200.

Referring again to FIG. 4, the battery-powered device 200 comprises a battery 210, a usage monitor 220, a controller 230, a memory 240, and a computer program 250 stored in the memory 240. The controller 230 executes the computer program 250. When executed, instructions of the computer program 250 receive data from the usage monitor 220 and produce a recommendation of a battery type from the received data. In some embodiments, the battery-powered device 200 further comprises a user interface 260. Instructions of the computer program 250 employ the user interface 260 to communicate the recommendation of battery type to the user of the battery-powered device 200.

In some embodiments, the usage monitor 220 is an energy monitor 220. In these embodiments, the energy monitor 220 monitors energy consumed by the device 200 as a function of time. In particular, the energy monitor 220 measures the energy used by the device 200 from the battery 210 while the device 200 is being used. The energy monitor 220 may be a discrete component in the device 200. Alternatively, the energy monitor 220 may be a portion of a multifunction component of the device 200 such as a microprocessor or an application specific integrated circuit (ASIC).

The energy monitor 220 also may record a time record of the energy consumed. Alternatively, the energy monitor 220 merely measures energy consumed and communicates data regarding the consumed energy to the controller 230 for storage in the memory 240, for example. In particular, monitored results generated by the usage monitor 220 are communicated to the controller wherein instructions of the computer program 250 record the usage and generate a time record thereof. Thus, the usage monitor 220 may be an ‘actual’ component that measures and records or the usage monitor 220 may be a ‘virtual’ component comprising both an actual portion, such as the energy monitor 220, and portions that are implemented as instructions in the computer program 250.

For example, the usage monitor 220 may comprise a current monitor 220 that monitors current in a connection between the battery 210 and electronics of the device 200. A wide variety of current monitors 220 are readily available from a number of integrated circuit (IC) manufacturers. An example of a current monitor 220 that employs a current-sense amplifier and a precision current sense resistor is a MAX471/472 Precision, High-Side Current-Sense Amplifier manufactured by MAXIM Integrated Products, Sunnyvale, Calif. The output analog data of the current-sense amplifier is converted to digital data by an analog-to-digital converter (ADC) of the device 200. Once converted, the data is received and processed into the time record by the controller 230 by executing particular instructions of the computer program 250.

In another example, the usage monitor 220 may employ a fuel gauge of the device. The fuel gauge measures or otherwise determines an amount of charge or energy that remains in the battery 210. A rate of change in the remaining energy in the battery 210 may be used to monitor device usage. Thus, by noting the reduction in remaining energy in the battery 210 as a function of time, the usage monitor 220 that employs the fuel gauge can monitor and record how the device is used as a function of time.

In yet other embodiments, the usage monitor 220 is entirely a portion of the computer program 250. In particular, the usage monitor 220 may comprise instructions of the computer program 250 that monitor and record operational modes of the device 200 as a function of time. As described hereinabove with respect to the method 100, monitoring and recording operational modes may be used to determine the usage of the device and develop a use model from the determined usage.

Referring once again to FIG. 4, instructions of the computer program 250 implement recommending a best-fit battery type based on the data generated by the usage monitor 220. In particular, instructions of the computer program 250 provide a mapping from the data to the best-fit battery type. Such a mapping may include, but is not limited to, listing available battery types in a database and employing a database function, such as a classifier, to choose a battery type to recommend based on the data. Thus, the computer program 250 may implement an embodiment of recommending 120 described hereinabove with respect to the method 100 of recommending.

Once the device 200 has formulated a recommendation, the battery type recommendation is communicated to the user of the device 200. In some embodiments, the user interface 260 of the device 200 is employed to communicate the recommendation to the user. In particular, a display unit of the user interface 260 may be employed to present a message to the user indicating that a particular battery type is recommended for use in the device.

FIG. 5 illustrates a perspective side view of an exemplary battery-powered digital camera as the device 200 according to an embodiment of the present invention. The side view illustrates the user interface 260, which includes a display unit 262. In some embodiments, the display unit 262 is a liquid crystal display (LCD) capable of generating and displaying alphanumeric messages. The user interface 260 may also include one or more keys or buttons 264 with which the user interacts with the digital camera 200.

Employing the display unit 262, the digital camera 200 presents a message to the user to indicate the recommended battery type. For example, the message may be displayed whenever a “low battery” condition occurs in the digital camera 200. An example of the displayed message is:
“Based on your usage of this camera, a nickel metal hydride (NiMH) battery may provide better performance and battery life than the currently installed battery type”
   The exemplary message above notifies the user of a use model-based recommendation regarding battery type. The user may choose to ignore the message or may act on the recommendation and install the recommended battery type.

In some embodiments, the battery-powered device 200 may further determine a battery type of a battery installed in the device 200. For example, a method of battery chemistry determination described hereinabove with respect to the method 100 may be employed by the device 200 to determine the installed battery type. The user interface 260 may communicate the determined installed battery type along with the recommended battery type, such as on the display unit 262 of the digital camera 200, for example.

In some embodiments, the device 200 may further recommend a supplier or retail source of the recommended battery type and/or connect to the Internet to enable the user to purchase the recommended battery type online using the device 200 and the user interface 260 thereof. An alternative exemplary message communicated to the user on the display unit 262, including results from an installed battery determination, might read:
“Installed Battery Type: Lithium (Li—FeS₂)
Recommended Battery Type: Nickel Cadmium (NiCd) NiCd batteries for this camera may be purchased from www.batteries-r-us.com or other fine battery suppliers.”

Thus, there have been described a method 100 of recommending a battery type based on a use model of a device. In addition, a battery-powered device 200 having a use model-based battery type selection has been described. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

1. A method of recommending a battery type for a battery-powered device, the method comprising:
recommending the battery type that has a constructive effect on one or both of device performance and battery performance or life during device usage, wherein recommending is based on a use model of the device.

2. The method of claim 1, wherein the recommended battery type is selected from a set of battery types that is usable with the device.

3. The method of claim 1, further comprising:
determining the use model of the device from monitoring the device usage.

4. The method of claim 3, wherein determining the use model comprises adapting the use model to changes in the monitored device usage over time.

5. The method of claim 4, wherein recommending the battery type comprises adapting to any changes in the adapted use model.

6. The method of claim 3, wherein the device usage is monitored comprising monitoring a parameter that yields data on one or both of the device performance and the battery performance or life using an installed battery, the data representing the use model.

7. The method of claim 3, wherein monitoring the device usage comprises measuring energy used by the device with an installed battery; and recording the measured energy used as a function of time.

8. The method of claim 7, wherein measuring and recording comprise measuring and recording one or more of a current flowing from the installed battery to the device, a current in a power supply of the device that is proportional to the current flowing from the installed battery, a peak or maximum energy used or drawn from the installed battery in a series of time intervals, a peak power per time interval, a decrease in energy stored in the installed battery, and energy remaining in the installed battery

9. The method of claim 3, wherein monitoring the device usage comprises recording as a function of time one or more of operational modes of the device and operations of the device performed using an installed battery to obtain recorded information; and optionally computing energy usage from the recorded information and from information regarding energy used by the respectively recorded information.

10. A method of recommending a battery type based on a use model of a battery-powered device, the method comprising:
monitoring usage of the device to determine the use model; and
recommending the battery type based on the monitored usage.

11. The method of claim 10, wherein the recommended battery type has a constructive effect on one or both of device performance and battery performance or battery life during device usage according to the use model.

12. The method of claim 10, wherein recommending the battery type comprises mapping results from the monitored usage into a database of characteristics for a set of battery types usable by the device.

13. The method of claim 12, wherein recommending the battery type further comprises suggesting a source for the recommended battery type.

14. The method of claim 10, further comprising:
determining a battery type that is installed in the device during monitoring usage.

15. The method of claim 14, wherein determining a battery type comprises one or more of inputting an identifier for the installed battery by a user of the device that indicates the battery type and measuring a parameter of the installed battery with the device that relates to the battery type.

16. The method of claim 14, wherein the battery type of the installed battery is determined one or more of during monitoring usage, before monitoring usage, when a battery compartment of the device is accessed, when a battery type is recommended, when the device is first turned ON, when the use model changes, and periodically during use of the device.

17. A device having a use model-based adaptive battery type selection, the device comprising:
means for monitoring usage of the device by a user that determines a use model; and
means for recommending a battery type based on the determined use model, the battery type being from a set of battery types usable with the device.

18. The device of claim 17, wherein the means for monitoring comprises an energy consumption monitor that monitors energy consumed from a battery installed in the device as a function of time during the device usage.

19. The device of claim 17, wherein the means for recommending comprises a mapping function that relates monitored usage from the monitoring means to a recommended battery type from the set of battery types, the recommended battery type having a constructive effect on one or both of device performance and battery performance or life during device usage according to the use model.

20. A battery-powered device having a use model-based adaptive battery type selection, the device comprising:
a monitor that monitors device usage and determines a use model;
a controller that controls the monitor;
a memory; and
a computer program stored in the memory and executed by the controller, the computer program comprising instructions that, when executed by the controller, recommend a battery type based on the determined use model.

21. The device of claim 20, wherein the recommended battery type has a constructive effect on one or both of device performance and battery performance or life during the device usage according to the use model.

22. The device of claim 20, further comprising:
a user interface accessible to the user, the instructions of the computer program employ the user interface to communicate the recommended battery type to the user under the control of the controller.

23. The device of claim 20, wherein the instructions of the computer program that recommend the battery type comprises a mapping function that relates the monitored device usage to a battery type in a database of battery types used with the device.

24. The device of claim 20, wherein the monitor is an energy monitor that monitors one or more of energy consumed by the device and energy remaining in a battery installed in the device as a function of time during device usage to determine the use model.

25. The device of claim 20, wherein the monitor is a portion of the computer program, the monitor portion of the computer program comprises instructions that, when executed by the controller, monitor and record operational modes of or operations performed by the device as a function of time during device usage to determine the use model.
